(19) United States
(12) Patent Application Publication
(10) Pub. No.: US 2008/0005903 A1
(43) Pub. Date: Jan. 10, 2008

(54) External datum system and film hole positioning using core locating holes

(75) Inventors: Ricardo Trindade, Coventry, CT (US); Edward F. Pietraszkiewicz, Southington, CT (US); Mathew C. Gartland, Hamden, CT (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: UNITED TECHNOLOGIES CORPORATION

(21) Appl. No.: 11/481,110

(22) Filed: Jul. 5, 2006

(51) Int. Cl. B23P 17/00; B23P 15/04; B21B 1/46

(52) U.S. Cl. 29/889.2; 29/527.5; 29/527.6; 29/557

(57) ABSTRACT

A turbine engine structure is provided that includes a wall having an exterior surface defining an internal passage. A locating hole extends through the wall from the exterior surface to the passage. A film hole is recessed in the exterior surface and adjoins the locating hole. The film hole and locating hole are in communication with the passage. The locating hole is formed during the casting process in which a core is supported with a locating pin. Upon removal of the locating pin, the locating hole is formed. The locating holes can be used to determine a position of features of the structure for subsequent processing operations of the structure. For example, film holes are machined in the exterior surface, such as by an electrical discharge machining process, to intersect the locating holes.

### BACKGROUND OF THE INVENTION

This invention relates to turbine engine structures having cooling passages and film holes.

Gas turbine engines have numerous hollow structures that utilize film holes to create a boundary layer adjacent to the structure to lower the temperature of the structure. Example turbine engine structures include rotor blades, guide vanes, stator vanes, and blade outer air seals.

The hollow structures are typically cast using cores that are supported within molds. The cores are typically supported by pin-like devices that leave locating holes extending from an exterior surface of the structure through a wall to the passage formed by the core once the core and pin are removed.

The hollow structure typically undergoes machining operations subsequent to casting. Determining the location of the passages and other heat transfer features within the hollow structure accurately is desirable. Typically external features such as the blade tip and/or leading and trailing edges, in the case of a turbine blade, are used. A time consuming trial and error process is used to correlate the desirable film holes to internal features of the hollow structure. Furthermore, the lack of accuracy in locating the film holes often precludes the use of film holes in some desired location.

Film holes are typically arranged in rows on the exterior surface of the hollow structure. The locating holes are arranged outside of the rows and are configured such that they are not useful for providing a film boundary layer. The locating holes are generally considered an undesired byproduct of the casting process.

What is needed is a manner in which to accurately determine locations of the internal passages and other heat transfer features while taking advantage of the existence of the locating holes.

### SUMMARY OF THE INVENTION

A turbine engine structure is provided that includes a wall having an exterior surface defining an internal passage. A locating hole extends through the wall from the exterior surface to the passage. A film hole is recessed in the exterior surface and adjoins the locating hole. The film hole and locating hole are in communication with the passage.

The locating hole is formed during the casting process in which a core is supported with a locating pin. Upon removal of the locating pin, the locating hole is formed. The locating holes can be used to determinc a position of features of the structure for subsequent processing operations of the structure. The film holes are machined in the exterior surface, such as by an electrical discharge machining process, to intersect the locating holes.

Accordingly, the locations of internal passages and other heat transfer features are accurately determined. Moreover, the locating holes are utilized as film holes.

These and other features of the present invention can be best understood from the following specification and drawings, the following of which is a brief description.

### BRIEF DESCRIPTION OF THE DRAWINGS

FIG. 1 is a schematic view of a turbine engine.

FIG. 2 is an enlarged schematic view of a turbine section of the turbine engine shown in FIG. 1.

FIG. 3 is a schematic view of a mold and cores used to cast a turbine engine structure.

FIG. 4 is a cross-sectional view of the cores for an example rotor blade.

FIG. 5A is an enlarged cross-sectional view of another rotor blade in an area of the tip.

FIG. 5B is a perspective view of an exterior of the rotor blade shown in FIG. 5A.

FIG. 6 is a cross-sectional view of a locating hole and film hole according to one example.

### DETAILED DESCRIPTION OF THE PREFERRED EMBODIMENT

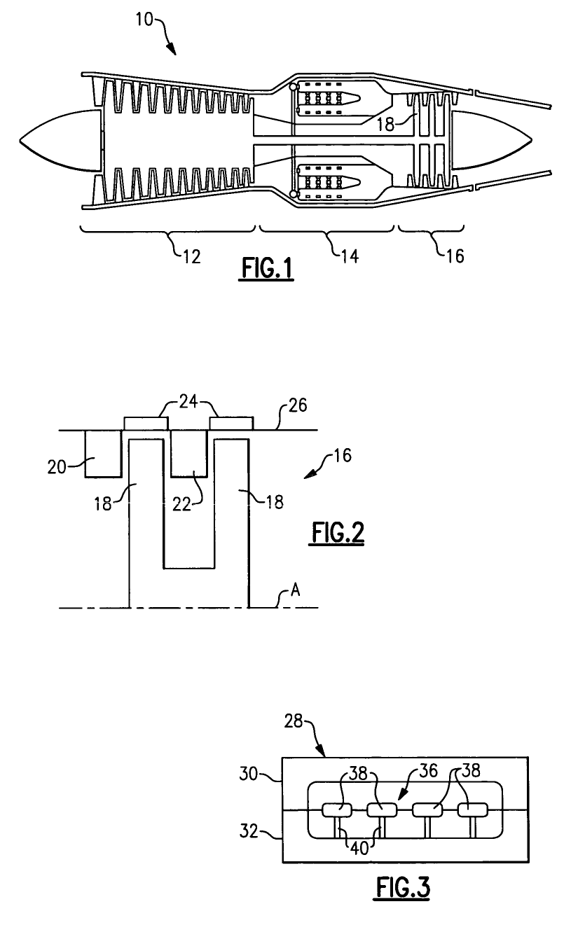

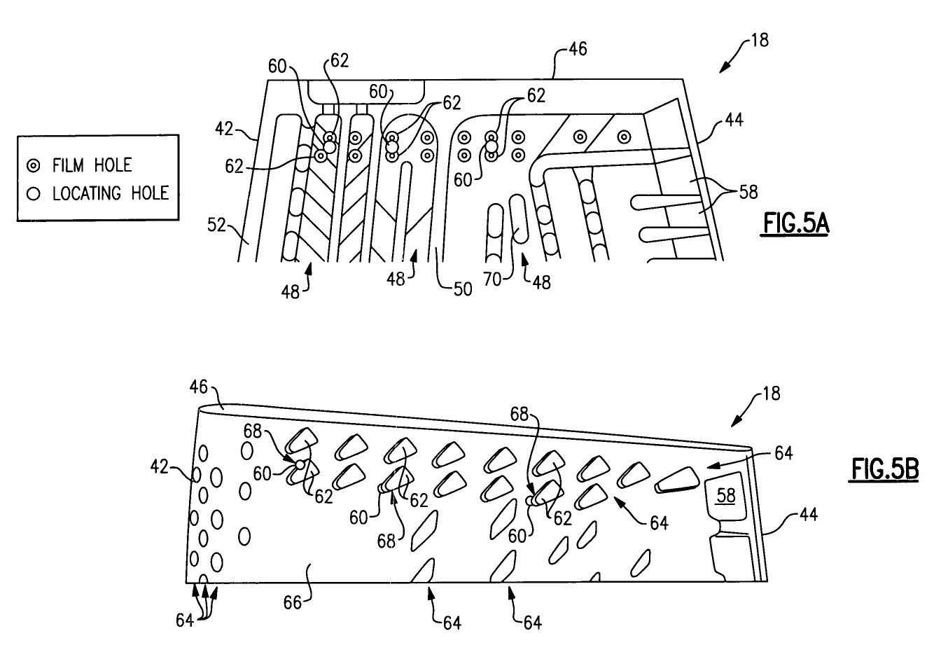

A gas turbine engine 10 is schematically shown in FIG. 1. The turbine engine 10 includes a compressor section 12, a combustor section 14, and a turbine section 16. The example turbine engine structure is illustrated as a rotor blade 18 in the example shown in FIG. 4-5B. However, it should be understood that the turbine engine structure can be any rotating or fixed component from a turbine section 16 or any other portion of a turbine engine. A turbine engine section 16 is schematically shown in FIG. 2. The turbine section 16 includes rotating structure such as rotor blades 18. The turbine section 16 also includes fixed structure such as guide and stator vanes 20, 22 and blade outer air seals 24 arranged on a case 26. These structures are well known in the art and typically include passages for providing a cooling fluid to film holes on an exterior of the structure.

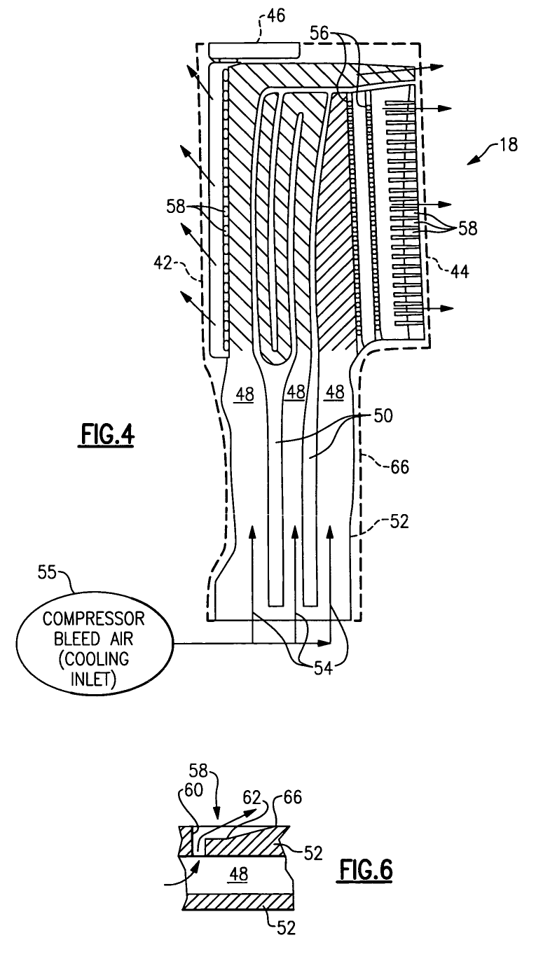

Hollow turbine engine structures are typically formed using a mold 28 having two or more portions, as schematically depicted in FIG. 3. The mold 28 includes first and second portions 30, 32 providing a cavity 36. One or more cores 38 are supported by pins 40 so that walls can be cast about the cores 38. The cores 38 can be, for example, refractory metal cores or ceramic cores. The pins 40 can be provided by a separate material such as a quartz rod or wax die or by protrusions provided by the parent core material, for example. The location and number of pins are determined so as to minimize the number of pins used. The cores 38 and pins 40 are removed, as is known in the art, to provide cooling passages in the space occupied by the cores. The openings left by the pins 40 in the prior art structures were undesired and typically resulted in parasitic cooling air outlets.

The turbine rotor blade 18 is shown in FIG. 4 as an example turbine engine structure. The rotor blades 18 includes leading and trailing edges 42, 44 and a tip 46 provided by the rotor blade's exterior surface 66, which is indicated by dashed lines in FIG. 4. Numerous passages 48 are provided by the cores 38 which are illustrated in FIG. 3. The passages 48 are defined by various ribs 50 and walls 52.

The rotor blade 18 includes inlets 54 that receives cooling air from a source 55, such as compressor bleed air. Various outlets 58 are provided on the exterior surface and are in communication with the inlets 54 via passages 48.

Referring to FIG. 5A, the outlets 58 are provided by film holes 62 arranged in one or more rows 64, some of which may be provided by the locating holes 60. Unlike the prior art, the locating holes 60 (left after removal of the pins 40) intersect or overlap the film holes 62. In this manner, the locating holes 60 are consumed by the film holes and are used to provide fluid from the passages to the film holes 62 to create the boundary layer on the exterior surface 66.

Referring to FIGS. 5B and 6, the locating holes 60 are shown in a generally normal angle relative to the exterior surface 66. The film holes 62 are at an acute angle relative to the exterior surface 66 and intersect the locating holes 60. The film holes 62 are typically machined using an electrical discharge machining process, for example. The film holes 62 form a generally frustoconical-shaped recess on the exterior surface 66 (FIG. 5B).

The locating holes 60 can be used to determine a position of other features of the structure for subsequent processing operations of the structure. Further, the locating holes 60 may not necessarily all be consumed by film holes 62. In the example described above, the locating hole 60 can be used to determine the position of the film holes 62. A coordinate measuring machine, for example, can identify the locating holes 60 and use them as datums to establish x, y, z coordinates. The rotor blade 18 and other turbine engine structures often include internal and cooling features 70 such as a pedestal or a trip strip within the passages 48 to enhance heat transfer, as is known in the art. The locating holes 60 can be used to locate the film holes 62 precisely relative to these and other internal and cooling features 70, which is particularly useful with highly curved airfoils.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of providing holes in a turbine engine structure comprising the steps of:
a) casting locating holes that extend to an exterior surface of a structure; and
b) machining film holes in the exterior surface to intersect the locating holes.

2. The method according to claim 1, comprising the step of locating a core within a mold using a pin, the pins providing the locating holes in step a).

3. The method according to claim 2, wherein the core provides a cooling passage in the structure, and the locating hole adjoins the cooling passage.

4. The method according to claim 3, wherein the film hole adjoins the cooling passage.

5. The method according to claim 1, wherein step b) removing material from the structure using an electrical discharge machine.

6. A method of providing a datum system for a turbine engine structure comprising the steps of:
a) supporting a core with a locating pin;
b) casting a structure about the core forming a locating hole with the locating pin; and
c) using the locating hole to determine a position for subsequent processing operations of the structure.

7. The method according to claim 6, wherein step a) includes supporting the core in a mold.

8. The method according to claim 6, wherein step b) includes removing the pin from the structure to form the locating hole.

9. The method according to claim 6, wherein step b) forms a passage within the structure when the core is removed from the structure, the locating hole adjoining the passage.

10. The method according to claim 9, wherein step c) includes determining the position of one of a trip strip, pedestal and the passage.

11. The method according to claim 10, wherein step c) includes machining a film hole adjoining the locating hole.

12. The method according to claim 11, wherein multiple pins form multiple locating holes arranged in a row, and step c) includes machining multiple film holes adjoining the multiple locating holes, the multiple film holes arranged in the row.

13. A turbine engine structure comprising:
a wall having an exterior surface and a defining a passage, a locating hole extending through the wall from the exterior surface to the passage, and a film hole recessed in the exterior surface adjoining the locating hole and in communication with the passage.

14. The turbine engine structure according to claim 13, comprising multiple film holes arranged in a row, the locating hole lying within the row.

15. The turbine engine structure according to claim 13, wherein the film hole provides a generally frustoconical-shaped recess.

16. The turbine engine structure according to claim 13, comprising an inlet in communication with the passage and an outlet provided by the film hole and locating hole.

17. The turbine engine structure according to claim 13, wherein the film hole and locating hole overlap one another.
